(19) United States
(12) Patent Application Publication
(10) Pub. No.: US 2008/0248451 A1
(43) Pub. Date: Oct. 9, 2008

(54) Method and apparatus for improved memory retention

(76) Inventor: Anthony G. Emerson, West Covina, CA (US)

Correspondence Address: SANDRA LEE LIPKIN;A LAW CORPORATION, 1891 GOODYEAR AVE., SUITE 622, VENTURA, CA, 93003, US

(21) Appl. No.: 11/784,647

(22) Filed: Apr. 6, 2007

(51) Int. Cl. G09B 19/00

(52) U.S. Cl. 434/236

(57) ABSTRACT

A method for improving human memory through the exploitation of the functions of both sides of the human brain that involves the reading of material aloud with one eye and the opposite ear covered and a second reading of the same material aloud with the other eye and the ear opposite the other ear covered and an headset apparatus for the facilitation of said method, with an optional recording mechanism that plays back in the ear of the plugged ear a recording read through a microphone that extends in front of the subject's mouth, said apparatus being usable on both sides of the human subject's head.

### BACKGROUND OF THE INVENTION

1. Field of the Invention

The present invention relates generally to the field of human memory improvement, and particularly to a method for utilizing each half of the human brain and apparatus for facilitation of the method.

2. Description of the Prior Art

Human understanding of the field of memory improvement and neuroscience is growing all the time. It is well known that both sides of brain operate to achieve different mental and physical functions. Stroke victims whom have had one or the other side of their brains damaged have seen deleterious effects to both the physical body and the mental acuity of the brain.

The brain is a thinking organ that learns and grows by interacting with the world through perception and action. Mental stimulation improves brain function and actually protects against cognitive decline, as does physical exercise. Throughout life, the brain's neural networks reorganize and reinforce themselves in response to new stimuli and learning experiences. This body-mind interaction is what stimulates brain cells to grow and connect with each other in complex ways.

Infants and children see the world as a place filled with curious wonders, delightful discoveries and daunting challenges. Human brains are taking in countless bits of information and are developing lifetime skills. The burst of learning in youth is remarkable, but the human brain can continue to grow and improve with exercise at any age. Many exercises and methods have been shown to improve memory. Some of these exercises involve the known separation of the brain functions into two hemispheres. These types of exercises often utilize a brain/body switch, switching the hand one would normally use to perform routine daily functions. Some examples of these types of exercises include using non-dominant hand to perform everyday functions such as using the mouse on a personal computer, brushing one's teeth, dialing the telephone or operating the television remote. Athletes improve their physical skills by dribbling basketballs, shooting basketballs and hitting baseballs with their non-dominant hand.

Combining two senses is also a known method of improving mental acuity. Such activities can include listening to music and smelling flowers simultaneously, listening to rain and tapping your fingers simultaneously or watching clouds and playing with modeling clay simultaneously.

Other brain acuity improvement tools include the use of so-called “smart drugs,” eating “brain foods,” listening to music, getting adequate sleep, and increasing physical activity.

So-called memory champions use a variety of techniques to demonstrate remarkable feats of memory such as the memorization of thousands of digits, entire epic poems or hundreds of unrelated words. Actors attach emotional meaning to what they say, enabling them to improve their memory of dialogue. Simple strategies, such as revising one's routine to always keep things in the same place, are also used to improve memory for some people.

Neurofeedback is a memory retention method that is not well understood but is becoming recognized as a credible form of memory improvement. Neurofeedback grew out of biofeedback therapy, which works by showing a subject real-time measures of some seemingly uncontrollable aspect of their physiology, such as heart rate, and encouraging the subject to try and change it. Many patients found they had such control, but could not explain how it was accomplished.

Until recently, a person's IQ—which measures all kinds of mental problem-solving abilities, including special skills, memory and verbal reasoning—was thought to be a fixed commodity largely determined by genetics. Recent hints suggest, however, that the very basic brain function known as working memory might underlie our general intelligence, opening up the possibility that if one improves his or her working memory, one can likewise boost his or her IQ. There has been some indication that the neural systems that underlie working memory may grow in response to training.

A few U.S. patents have been issued to attempt to improve memory using complicated electronics and computer interface or the stimulation of the vagus nerve. See U.S. Pat. No. 6,615,197 to Chai and U.S. Pat. No. 6,556,868 to Naritoku et al. Heretofore, there has not been known a simple method that improves memory that utilizes the known neuroscience of the two separate functions of each hemisphere of the brain. Therefore, there is a need for a method of improving learning and memory retention that is simple and that exploits many of the known functions of the brain in improving memory and results in improvements in IQ as a result.

### SUMMARY OF THE INVENTION

The preferred embodiment of the present invention teaches a method for the improvement of memory of a human subject comprising first covering the subject's first eye with a covering means; second, plugging the subject's first ear on the opposite side of the subject's body from the first eye with a plugging means; third, the reading aloud of material for the subject to remember; fourth, removing the covering means from the subject's first eye; fifth, removing the plugging means from the subject's first ear; sixth, covering the subject's second eye on the opposite side of the subject's body from the first eye with a covering means; seventh, plugging the subject's second ear on the opposite side of the subject's body from the second eye with a plugging means; and eighth, the reading aloud of the material for the subject to remember.

Yet another embodiment of the present invention modifies the embodiment above by further defining that the covering means is an eye patch.

Yet another embodiment of the present invention modifies the embodiment above by further defining that the plugging means is an earplug.

Yet another embodiment of the present invention modifies the embodiment above by further defining that the covering means and the plugging means are combined in single device that can be used interchangeably with the first eye and the first ear as well as the second eye and the second ear.

Yet another embodiment of the present invention modifies the embodiment above by further defining that the method further comprises the steps of providing a recording means into which the subject can read aloud the material for the subject to remember and providing a playback means into the subject's first ear or the subject's the second ear that plays back the recording made by the recording means through the ear plugging means.

Yet another embodiment of the present invention modifies the embodiment above by further defining that the covering means, the plugging means, the recording means and the playback means are combined in a single device that can be used interchangeably with the first eye and the first ear as well as the second eye and the second ear.

A second embodiment of the present invention is a headset for the improvement of memory of a human subject whereby the subject first covers a first eye and unplugs the first ear located on the opposite side of the subject's body than the first eye, and reads aloud material to be remembered and then uncovers the first eye and unplugs the first ear and then covers the second eye on the opposite side of the subject's body and plugs the second ear located on the opposite side of the subject's body than the second eye, again reading aloud the material, the headset comprising a flexible support that surrounds the subject's ear and a plugging means attached to the flexible support that plugs the subject's same ear as that surrounded by the flexible support, and a covering means attached to the flexible support that covers the subject's eye that is located on the opposite side of the subject's body than the ear.

Yet another embodiment of the present invention modifies the embodiment above by further defining that the covering means is an eye patch.

Yet another embodiment of the present invention modifies the embodiment above by further defining that the plugging means is an earplug.

Yet another embodiment of the present invention modifies the embodiment above by further defining that the headset further comprises a recording means into which the subject can read aloud the material for the subject to remember wherein the recording means is attached to the flexible support and extends toward the subject's mouth and a playback means into the subject's plugged ear that plays back the recording made by the recording means wherein the playback means is located inside of the plugging means.

### BRIEF DESCRIPTION OF THE DRAWINGS

FIG. 1 is a flow chart outlining the steps involved in the first embodiment of the invention.

FIG. 2 is a diagram showing the neurological basis of the utility of the invention.

FIG. 3 is a view of a human subject wearing an alternative embodiment of the invention utilizing the recording and playback portion of the headset.

FIG. 4 is a perspective view of the headset of the preferred embodiment of the invention.

### DETAILED DESCRIPTION OF A PREFERRED EMBODIMENT

Below is a list of the reference numerals defining which items are defined by which numerals:
10 brain
11 visual pathway
12 optic nerve
13 optic chasm
14a visual stimuli
14b visual stimuli
15 left retina
16 right retina
17 optic tracks
18 left dorsal lateral geniculate nucleus
19 right dorsal lataeral geniculate nucleus
20 lateral geniculate bodies
21 optic radiation
22 left occipital lobe
23 right occipital lobe
24 apparatus headset
25 human subject
27 ear
28 eye covering means
29 ear plugging means
30 microphone
31 mouth
33 flexible support piece
34 first frame portion
35 nose bridge
36 second frame portion
38 hinge

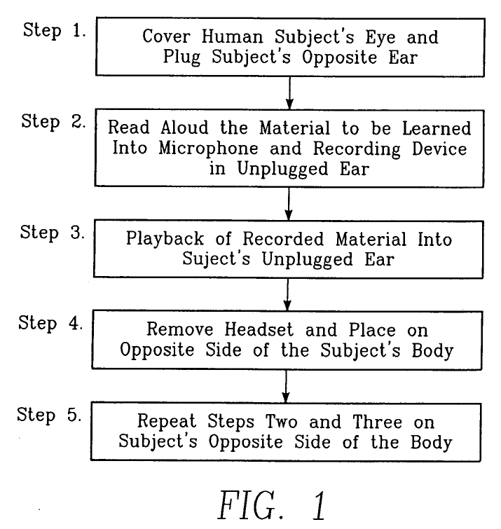

The method of the instant invention involves several steps. These steps are outlined in the flow chart of FIG. 1. The efficacy of the within invention can be measured by performing a baseline test, not involving the method described herein, then by repeating the test with the method defined herein and comparing the results. Tests conducted heretofore have shown dramatic improvements in the memory retention of subjects of all ages and all abilities, including subjects challenged with dyslexia.

The baseline test is a traditional test wherein the subject reads a factual paragraph out loud and clearly. Once read, the paper is removed from the subject. The paper is then returned to the subject for a second out loud reading, after which the paper is again removed. The subject is then quizzed on the facts outlined in the paragraph and graded according the number of questions answered correctly.

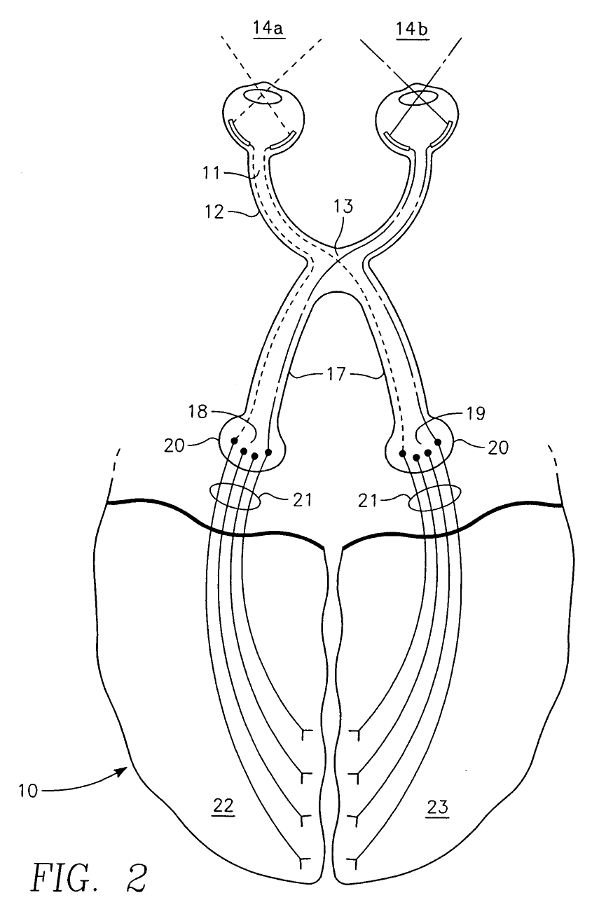

The method of the within invention also involves two readings of the subject material. However, the first time the material is read, one eye is covered while the ear on the opposite side of the body as the covered eye is also plugged. The material is then removed from the subject while the eye cover and ear plug are moved to the opposite sides of the subject's body. The material is then read aloud one more time and the subject tested for facts contained in the reading material. Dramatic improvements in retention are found due to the neurological pathways utilizing both sides of the brain, as shown in FIG. 2.

FIG. 2 outlines generally the understanding of the neurological pathways that define the correlation between each side of the brain 10 and the visual pathway 11 of the optic nerve 12. The optic chasm 13 is located at the interface of the two pathways of the optic nerve 12. Visual stimuli 14a, 14b are projected onto the left retina 15 and the right retina 16.

The optic tracks 17 travel from the optic chasm 13 and provide projections on the left dorsal lateral geniculate nucleus 18 and the right dorsal lateral geniculate nucleus 19, which are located in the lateral geniculate bodies 20.

Optic radiation 21 occurs between the lateral geniculate bodies 20 and the brain 10. There finally occurs a projection on the left occipital lobe 22 and the right occipital lobe 23 of the brain 10.

The Visual Pathway and the Learning Process are inter-related through the same pathway. This pathway begins with the retina. Each eye-ball has 2 optic nerves attached, one on the outer peripheral and an inner nose bridge location. The outer peripheral optic nerve travels along the same side of the brain to project on the left and right Dorsal Lateral Geniculate Nucleus through optic radiation to projection on either the left or right Occipital Lobe in the Calcarine Sulcus. On the other hand the inner optical nerve on each side of the nose bridge travel and criss crosses in the Optic Chiasm and travel on the opposite side of the brain causing the visual and learning process to register on the opposite side of the brain in which the original eye observed. Understanding this pathway, we can effectively change the way we learn and retain information. In effect, by blocking the right or left vision during the learning process will allow maximum proficiency to the targeted hemisphere for maximum comprehension. Training separate hemispheres of the brain insures a maximum retention and comprehension.

The method as outlined in FIG. 3 is further facilitated with the apparatus that is defined in the preferred embodiment of the invention. The apparatus 24 is a headset that attaches to one of either sides of a human subject's 25 body. Included in this apparatus 24 is a means 28 for covering one eye of the human subject 25 while simultaneously plugging the opposite ear 27 of the human subject 25. The eye covering means 28 is an eye patch as shown in FIG. 3 but could be any means that blocks visual stimuli from entering the eye. Similarly, the ear plugging means 29 as shown in FIG. 3 is an ear plug, but could be any means that blocks aural stimuli from entering the ear 27.

The preferred embodiment includes a microphone 30, which is positioned in front of the subject's 25 mouth 31, thereby allowing the subject 25 to read the subject matter to be mastered into a recording device (not shown) located in the ear plug 29 of the headset apparatus 24.

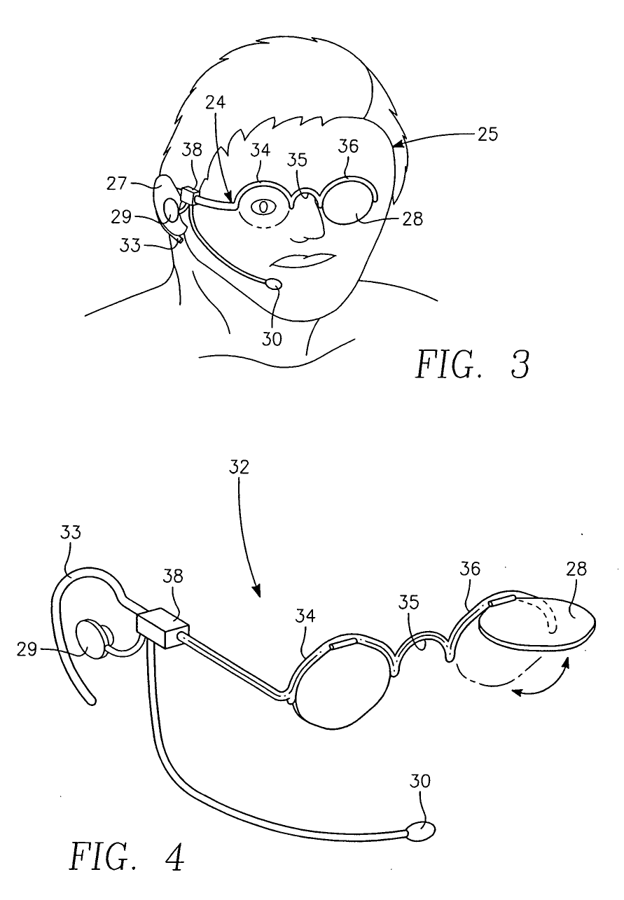

FIG. 4 illustrates a perspective view of the apparatus 24 apart from the head of the human subject. The apparatus 24 includes a flexible support 33 that covers the subject's 25 ear 27. The flexible support 33 is attached to a first frame portion 34 that is attached to a nose bridge 35. Attached to the nose bridge 35 is a second frame portion 36 that holds the eye covering means 28, in this case an eye patch that is foldable to cover either eye, depending upon which side of the brain is being engaged.

The illustrations and examples provided herein are for explanatory purposes and are not intended to limit the scope of the appended claims. This disclosure is to be considered an exemplification of the principles of the invention and is not intended to limit the spirit and scope of the invention and/or claims of the embodiment illustrated. Those skilled in the art will make modifications to the invention for particular applications of the invention.

What is claimed is:

1. A method for the improvement of memory of a human subject comprising
covering said subject's first eye with a covering means;
plugging said subject's first ear on the opposite side of said subject's body from said first eye with a plugging means;
the reading aloud of material for said subject to remember;
removing said covering means from said subject's first eye;
removing said plugging means from said subject's first ear;
covering said subject's second eye on the opposite side of said subject's body from said first eye with a covering means;
plugging said subject's second ear on the opposite side of said subject's body from said second eye with a plugging means; and
the reading aloud of said material for said subject to remember.

2. A method according to claim 1 wherein said covering means is an eye patch.

3. A method according to claim 1 wherein said plugging means is an earplug.

4. A method according to claim 1 wherein said covering means and said plugging means are combined in single device that can be used interchangeably with said first eye and said first ear as well as said second eye and said second ear.

5. A method according to claim 1 wherein said method further comprises the steps of
providing a recording means into which said subject can read aloud said material for said subject to remember;
providing a playback means into said subject's said first ear or said subject's said second ear that plays back the recording made by said recording means through said ear plugging means.

6. A method according to claim 1 wherein said covering means, said plugging means, said recording means and said playback means are combined in a single device that can be used interchangeably with said first eye and said first ear as well as said second eye and said second ear.

7. A headset for the improvement of memory of a human subject whereby said subject first covers a first eye and plugs a first ear located on the opposite side of said subject's body than said first eye, and reads aloud material to be remembered and then uncovers said first eye and unplugs said first ear and then covers the second eye on the opposite side of said subject's body and plugs the second ear located on the opposite side of said subject's body than said second eye, again reading aloud said material, said headset comprising
a flexible support that surrounds said subject's ear;
a plugging means attached to said flexible support that plug's said subject's same ear as that surrounded by said flexible support; and
a covering means attached to said flexible support that covers said subject's eye that is located on the opposite side of said subject's body than said ear.

8. A headset according to claim 7 wherein said covering means is an eye patch.

9. A headset according to claim 7 wherein said plugging means is an earplug.

10. A headset according to claim 7 wherein said headset further comprises
a recording means into which said subject can read aloud said material for said subject to remember wherein said recording means is attached to said flexible support and extends toward said subject's mouth; and
a playback means into said subject's said plugged ear that plays back the recording made by said recording means wherein said playback means is located inside of said plugging means.
